(19) United States
(12) Patent Application Publication
(10) Pub. No.: US 2025/0330721 A1
(43) Pub. Date: Oct. 23, 2025

(54) IMAGE PROCESSING DEVICE AND IMAGE PROCESSING METHOD

(71) Applicant: SK hynix Inc., Icheon-si Gyeonggi-do (KR)

(72) Inventors: Jae Hyun IM, Icheon-si Gyeonggi-do (KR); Joo Young KIM, Icheon-si Gyeonggi-do (KR); Jong Woon YOON, Icheon-si Gyeonggi-do (KR)

(73) Assignee: SK hynix Inc., Icheon-si Gyeonggi-do (KR)

(21) Appl. No.: 19/054,279

(22) Filed: Feb. 14, 2025

(30) Foreign Application Priority Data
Apr. 17, 2024 (KR) 10-2024-0051143

(51) Int. Cl. H04N 23/86; H04N 25/611

(52) U.S. Cl. CPC H04N 23/86; H04N 25/611

(57) ABSTRACT

An image processing device and an image processing method are provided. The image processing device includes a grayscale map generator configured to selectively identify luminance map data based on a saturation map and a luminance map that correspond to an input image, and configured to generate a grayscale map based on at least one of the identified luminance map data. The image processing device also includes a noise corrector configured to generate processed image data for which a noise value for the input image is corrected based on the grayscale map.

### CROSS-REFERENCE TO RELATED APPLICATION

The present application claims priority under 35 U.S.C. § 119 (a) to Korean patent application No. 10-2024-0051143, filed on Apr. 17, 2024, in the Korean Intellectual Property Office, the entire contents of which application is incorporated herein by reference.

### TECHNICAL FIELD

The technology and implementations disclosed in this patent document generally relate to an image processing device and an image processing method that can perform image conversion.

### BACKGROUND

An image sensing device is a device for capturing optical images by converting light into electrical signals using a photosensitive semiconductor material which reacts to light. With the development of automotive, medical, computer, and communication industries, the demand for high-performance image sensing devices is increasing in various fields such as smartphones, digital cameras, game machines, IoT (Internet of Things), robots, security cameras, and medical micro cameras.

An image sensing device converts a light signal detected by a pixel array into an electrical signal. When the image sensing device converts a light signal into an electrical signal, a direct current (DC) offset may occur. When the DC offset occurs, luminance (brightness) of a final image becomes brighter by the amount of the DC offset, and thus a contrast between bright and dark areas of the image may decrease.

### SUMMARY

In accordance with an embodiment of the disclosed technology, an image processing device may include: a grayscale map generator configured to selectively identify a luminance map data based on a saturation map and a luminance map that correspond to an input image, and configured to generate a grayscale map based on the identified luminance map data; and a noise corrector configured to generate processed image data for which a noise value for the input image is corrected based on the grayscale map.

In accordance with another embodiment of the disclosed technology, an image processing device may include: a grayscale map generator configured to selectively identify a luminance map data based on a saturation map and a luminance map that correspond to an input image, and configured to generate a grayscale map based on the identified luminance map data; a dark area detector configured to detect a dark area from among areas of the grayscale map; and a noise calculator configured to calculate a noise value for the input image based on pixel data for one or more pixels included in the dark area.

In accordance with another embodiment of the disclosed technology, an image processing device may include: a saturation map generator configured to generate a saturation map based on a standard deviation between pixel data for a plurality of pixels; a luminance map generator configured to generate a luminance map by extracting luminance information from the plurality of pixels; a grayscale map generator configured to selectively identify a luminance map data based on the saturation map and the luminance map, and configured to generate a grayscale map based on the identified luminance map data; and a dark area detector configured to detect a dark area from among areas of the grayscale map.

In accordance with another embodiment of the disclosed technology, an image processing method may include: identifying data based on a first threshold value from among data of a luminance map for an input image; identifying data that is less than or equal to a second threshold value from among data of a saturation map for the input image; detecting a dark area based on the data that is less than or equal to the first threshold value and the data that is less than or equal to the second threshold value; and calculating a direct current (DC) offset noise value for the input image based on the detected dark area.

### BRIEF DESCRIPTION OF THE DRAWINGS

The above and other features and aspects of the disclosed technology will become readily apparent with reference to the following detailed description when considered in conjunction with the accompanying drawings.

FIG. 1 is a block diagram illustrating an example of an image signal processor included in an image processing device based on some implementations of the disclosed technology.

FIG. 2 is a block diagram illustrating an example of a mapping data generator based on some implementations of the disclosed technology.

FIG. 3 is a block diagram illustrating an example of a noise corrector based on some implementations of the disclosed technology.

FIG. 4 is a flowchart illustrating example operations of the image signal processor based on some implementations of the disclosed technology.

FIG. 5 is a graph illustrating an example of pixel data in a high-illuminance environment based on some implementations of the disclosed technology.

FIG. 6 is a graph illustrating an example of pixel data in a medium-illuminance environment based on some implementations of the disclosed technology.

FIG. 7 is a graph illustrating an example of pixel data in a low-illuminance environment based on some implementations of the disclosed technology.

FIG. 8 is a diagram illustrating an example of mapping data based on some implementations of the disclosed technology.

FIG. 9 is a block diagram illustrating an example of a computing device corresponding to the image processing device of FIG. 1 based on some implementations of the disclosed technology.

### DETAILED DESCRIPTION

This patent document provides implementations and examples of an image processing device and an image processing method that can perform image conversion that may be used in configurations to substantially address one or more technical or engineering issues and to mitigate limitations or disadvantages encountered in some image processing devices in the art. Some implementations of the disclosed technology relate to an image processing device capable of correcting direct current (DC) offset noise. Some implementations of the disclosed technology relate to an image processing method that detects DC offset noise and corrects image signals based on the detected noise. In recognition of the issues above, an image processing device may generate a high-contrast image even when DC offset noise occurs. Even when a noise value is amplified by applying an analog gain or a digital gain to the image processing device in a low-illuminance environment, the image processing device may correct the amplified noise value.

Reference will now be made in detail to some embodiments of the disclosed technology, examples of which are illustrated in the accompanying drawings. Wherever possible, similar reference numbers are used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereinafter, various embodiments are described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

Some embodiments of the disclosed technology relate to an image processing device capable of correcting direct current (DC) offset noise. Other embodiments of the disclosed technology may relate to an image processing method that detects DC offset noise and corrects image signals based on the detected noise. It is to be understood that both the foregoing general description and the following detailed description of the disclosed technology are illustrative and explanatory and are intended to provide further explanation of the disclosure as claimed.

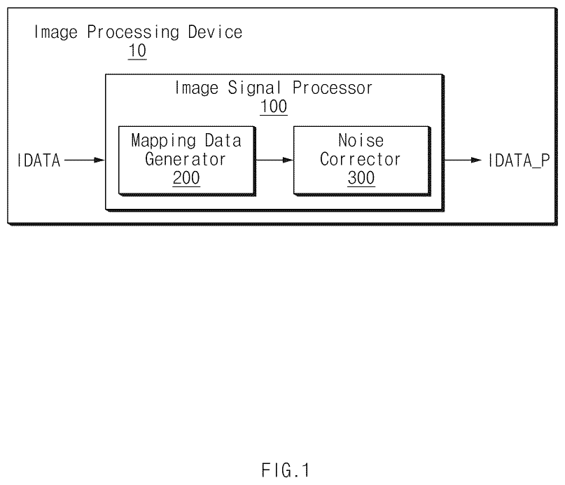

FIG. 1 is a block diagram illustrating an example of an image signal processor (ISP) 100 included in an image processing device 10 based on some implementations of the disclosed technology.

Referring to FIG. 1, the image processing device 10 may be embedded in an electronic device or may be implemented as an electronic device. Here, the electronic device may capture (or photograph) an image, may display the captured image, or may perform operations based on the captured image. In this case, the electronic device may be, for example, a digital camera, a smartphone, a wearable device, an Internet of Things (IoT) device, a personal computer (PC), a tablet computer, a personal digital assistant (PDA), a portable multimedia player (PMP), a navigation device, a drone, etc., or may be mounted to other devices serving as constituent elements of various electronic devices, such as, a vehicle, a medical device, furniture, manufacturing equipment, a security device, doors, a variety of measurement instruments, etc.

The image processing device 10 may include an image sensing device and an image signal processor (ISP) 100. The image signal processor 100 may perform at least one image signal process on image data (IDATA) to generate the processed image data (IDATA_P). The image signal processor 100 may reduce noise of image data (IDATA), and may perform various kinds of image signal processing (e.g., demosaicing, defect pixel correction, gamma correction, color filter array interpolation, color matrix manipulation, color correction, color enhancement, lens distortion correction, DC offset correction, etc.) for image-quality improvement of the image data. In addition, the image signal processor 100 may compress image data that has been created by execution of image signal processing for image-quality improvement, such that the image signal processor 100 can create an image file using the compressed image data. Alternatively, the image signal processor 100 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created.

The image data (IDATA) may be generated by the image sensing device that captures an optical image of a scene, but the scope of the disclosed technology is not limited thereto. The image sensing device may include a pixel array including a plurality of pixels configured to sense incident light received from a scene, a control circuit configured to control the pixel array, and a readout circuit configured to output digital image data (IDATA) by converting an analog pixel signal received from the pixel array into the digital image data (IDATA). In some implementations of the disclosed technology, it is assumed that the image data (IDATA) is generated by the image sensing device.

The image data (IDATA) may include noise due to defects in pixels or errors that occur in the process of converting light signals into electrical signals. In particular, when an analog gain or a digital gain is applied to image data under a low-illuminance environment, noise of the image data may also be amplified. In some implementations, for convenience of description and better understanding of the disclosed technology, defects or errors that cause differences between image data (IDATA) and actual images will hereinafter be collectively referred to as “noise”.

To increase the quality of color images, the accuracy of correction of defective pixels can be improved. To this end, the image signal processor (ISP) 100 based on some implementations of the disclosed technology may include a mapping data generator 200 and a noise corrector 300.

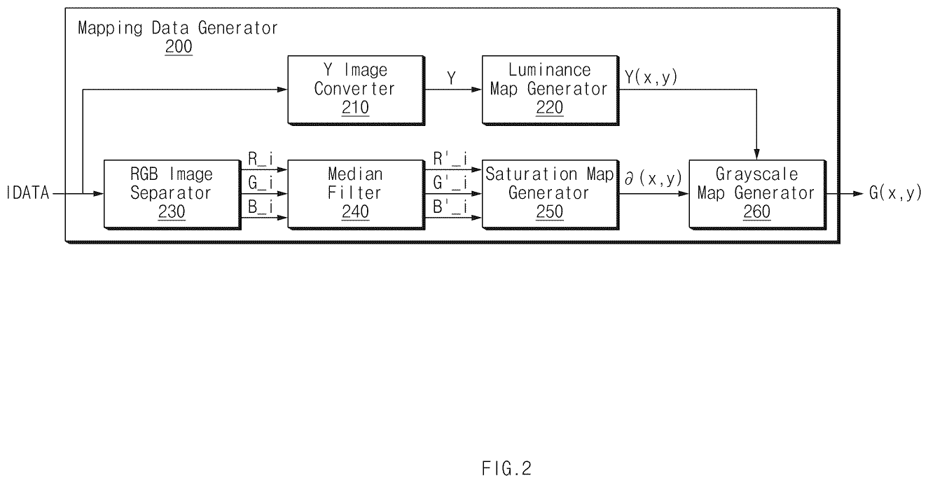

The mapping data generator 200 may generate mapping data used to detect noise in the image data (IDATA). In the following description, for convenience of description, digital data corresponding to a pixel signal of each pixel are defined as pixel data, and information indicating the position of a pixel corresponding to a mapping criterion and data of this pixel will hereinafter be defined as map data. For example, luminance map data for image data (IDATA) may correspond to data representing the position of each pixel for the image data (IDATA) and a luminance value of pixel data corresponding to the position of each pixel. More detailed operations of the mapping data generator 200 are described later with reference to FIG. 2.

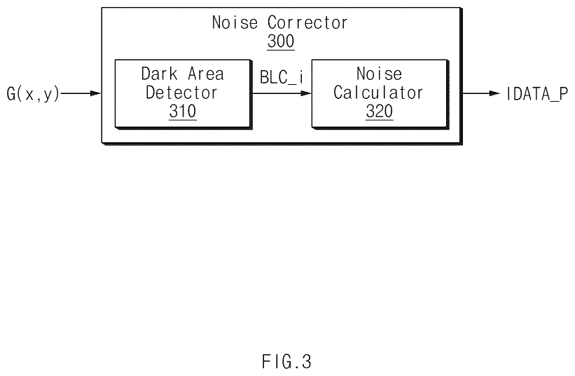

The noise corrector 300 may calculate a noise value based on the map data received from the mapping data generator 200. The noise corrector 300 may generate processed image data (IDATA_P) by correcting pixel data based on the calculated noise value. For example, the noise corrector 300 may generate processed image data (IDATA_P) by removing DC offset noise of pixel data based on the map data. More detailed operations of the noise corrector 300 are described later with reference to FIG. 3.

FIG. 2 is a block diagram illustrating an example of the mapping data generator 200 based on some implementations of the disclosed technology.

Referring to FIG. 2, the mapping data generator 200 may include a luminance (Y) image converter 210, a luminance map generator 220, an RGB image separator 230, a median filter 240, a saturation map generator 250, and a grayscale map generator 260. For example, the mapping data generator 200 may receive image data (IDATA) and may transmit grayscale map G(x,y) data to the noise corrector 300.

According to an embodiment, the luminance image converter 210 may receive image data (IDATA) from the image sensing device and may convert a color space domain of the received image data (IDATA). For example, the luminance image converter 210 may convert an RGB domain image of the image data (IDATA) into a YUV domain image or a YCbCr domain image. In an example, a color space domain conversion formula may use the Keith Jack conversion method or the Julen conversion method. For example, the Keith Jack conversion method may use formulas such as “Y=(0.257×R)+(0.504×G)+(0.098×B)+16”, “Cb=(0.439×R)+(0.368×G)−(0.071×B)+128”, and “Cr=−(0.148×R)−(0.291×G)+(0.439×B)+128” when trying to convert the RGB domain image into the YCbCr domain image. For example, when trying to convert the RGB domain image into the YCbCr domain image, pixel data corresponding to a red channel, pixel data corresponding to a green channel, and pixel data corresponding to a blue channel are substituted into the formula of the Keith Jack conversion method, data corresponding to Y, data corresponding to Cb, and data corresponding to Cr can be calculated.

According to an embodiment, the image data (IDATA) may correspond to the coordinate (x, y) of the pixel array, and the pixel coordinate may include pixels of a unit pattern. For example, (1, 1) of the pixel array may include a red channel pixel, two green channel pixels, or a blue channel pixel included in the unit pattern of the Bayer pattern. In an example, pixel data of two green channel pixels of the unit pattern may correspond to an average value of pixel data of two green channel pixels, and may include data Xᵢ(x, y). The pixel data may include pixel data corresponding to ‘i’ channel and pixel coordinate data. For example, pixel data located at the coordinate (1, 1) and corresponding to the red color channel may be represented by X_{R}(1, 1). For example, pixel data located at the coordinate (1, 1) and corresponding to the blue color channel may be represented by X_{B}(1, 1).

According to an embodiment, the luminance image converter 210 may transmit luminance data (Y) to the luminance map generator 220. In an example, the luminance image converter 210 may convert the RGB domain image of the image data (IDATA) into a YUV domain image or a YCbCr domain image, and may extract luminance data (Y) from the converted image. For example, the luminance image converter 210 may extract luminance data (Y) from the RGB image using the Keith Jack conversion method or the Julen conversion method, and may transmit the extracted luminance data (Y) to the luminance map generator 220.

According to an embodiment, the luminance map generator 220 may receive luminance data (Y) from the luminance image converter 210 and may generate a luminance map Y(x,y) based on the received luminance data (Y). For example, the luminance map generator 220 may use the luminance data (Y) to generate the luminance map Y(x,y) in which the luminance data (Y) and coordinate information (x,y) of the pixel array are combined with each other. In an example, the luminance map may correspond to mapping data indicating the luminance data (Y) of each coordinate of the pixel array. In an example, the luminance map generator 220 may transmit the luminance map Y(x,y) to the grayscale map generator 260. The luminance image converter 210 and the luminance map generator 220 based on some implementations of the disclosed technology are merely examples and may operate as a single module. For example, the luminance map generator 220 may receive image data (IDATA) to identify the luminance data (Y), and may generate a luminance map Y(x,y) by combining the identified luminance data (Y) with coordinate data of the image data (IDATA) corresponding to the identified luminance data (Y).

According to an embodiment, the RGB image separator 230 may receive image data (IDATA) from the image sensing device, and may classify the received image data (IDATA) into an R image (R_i) composed of pixel data corresponding to a red channel, a G image (G_i) composed of pixel data corresponding to a green channel, and a B image (B_i) composed of pixel data corresponding to a blue channel. In an example, the color domain of the image data (IDATA) may include another color domain other than the RGB domain. For example, the image data (IDATA) may correspond to an RGBW domain image including pixel data (W) corresponding to a white channel. For example, the image data (IDATA) may be classified by an image separator (not shown) into an R image composed of pixel data corresponding to a red channel, a G image composed of pixel data corresponding to a green channel, a B image composed of pixel data corresponding to a blue channel, and a W image composed of pixel data (W) corresponding to a white channel.

According to an embodiment, the R image (R_i), the G image (G_i), and the B image (B_i) generated by the RGB image separator 230 may correspond to data in which coordinate information (x,y) of the pixel array is combined. For example, upon receiving the image data (IDATA), the RGB image separator 230 may generate the R image (R_i) by combining pixel data corresponding to the red channel and coordinate information (x, y) of the pixel array. In an example, the R image (R_i) may correspond to mapping data indicating pixel data corresponding to the red channel for each coordinate of the pixel array. For example, upon receiving the image data (IDATA), the RGB image separator 230 may generate the G image (G_i) by combining pixel data corresponding to the green channel and coordinate information (x, y) of the pixel array. In an example, the G image (G_i) may correspond to mapping data indicating pixel data corresponding to the green channel for each coordinate of the pixel array. For example, upon receiving the image data (IDATA), the RGB image separator 230 may generate a B image (B_i) by combining pixel data corresponding to the blue channel and coordinate information (x,y) of the pixel array. In an example, the B image (B_i) may correspond to mapping data indicating pixel data corresponding to the blue channel for each coordinate of the pixel array.

According to an embodiment, the RGB image separator 230 may transmit the R image (R_i), the G image (G_i), and the B image (B_i) to the median filter 240. In an example, the RGB image separator 230 may separate the image data (IDATA) according to a plurality of color channels (e.g., the R channel, the G channel, and the B channel), and may transmit the separated images to the median filter 240.

According to an embodiment, the median filter 240 may receive the R image (R_i), the G image (G_i), and the B image (B_i) from the RGB image separator 230. In an example, the median filter 240 may remove noise included in the received R image (R_i), noise included in the G image (G_i), and noise included in the B image (B_i). In an example, the noise to be removed by the median filter 240 may be distinguished from the noise to be processed by the noise corrector 300 to be described later. For example, the median filter 240 may perform a pre-processing operation to assist the processing operation of the saturation map generator 250, the grayscale map generator 260, or the noise corrector 300. For example, the median filter 240 may remove pixel noise generated due to a pixel defect of the pixel array of the image sensing device. In an example, the median filter 240 may perform at least some of the image signal processing operations for improving the image quality of the image signal processor (ISP) 100 described above.

According to an embodiment, the median filter 240 may perform a pre-processing operation for removing noise included in the R image (R_i), noise included in the G image (G_i), and noise included in the B image (B_i), which have been received from the RGB image separator 230. The pre-processing operation may correspond to a pre-processing operation for a subsequent operation (e.g., a saturation map generation operation, a grayscale map generation operation, a dark area detection operation, or a noise calculation operation). In an example, the noise may include noise related to a defective pixel included in the R image (R_i), noise related to a defective pixel included in the G image (G_i), noise related to a defective pixel included in the B image (B_i), noise related to temporary light inflow, or noise related to signal overflow. In an example, the median filter 240 may generate a pre-processed R image (R′_i), a pre-processed G image (G′_i), and a pre-processed B image (B′_i). In an example, the median filter 240 may transmit the pre-processed R image (R′_i), the pre-processed G image (G′_i), and the pre-processed B image (B′_i) to the saturation map generator 250.

According to an embodiment, the saturation map generator 250 may receive a pre-processed R image (R′_i), a pre-processed G image (G′_i), and a pre-processed B image (B′_i) from the median filter 240. In an example, the saturation map generator 250 may generate a saturation map (∂(x,y)) based on the received pre-processed R image (R′_i), the pre-processed G image (G′_i), and the pre-processed B image (B′_i). In an example, the saturation map generator 250 may identify pixel data corresponding to a red channel for each coordinate, pixel data corresponding to a green channel for each coordinate, and pixel data corresponding to a blue channel for each coordinate by using the pre-processed R image (R′_i), the pre-processed G image (G′_i), and the pre-processed B image (B′_i).

According to an embodiment, the saturation map generator 250 may generate a saturation map (∂(x,y)) in which the coordinate information (x,y) of the pixel array is combined with standard deviations according to coordinates of pixel data corresponding to the identified red channel, pixel data corresponding to the identified green channel, and pixel data corresponding to the identified blue channel. In an example, the standard deviation for each coordinate of pixel data corresponding to the red channel, pixel data corresponding to the green channel, and pixel data corresponding to the blue channel may correspond to saturation for each coordinate of the image data (IDATA).

For example, as the image data (IDATA) is closer to the achromatic color, pixel data of the R channel, pixel data of the G channel, and pixel data of the B channel are the same or similar to each other, and thus the standard deviation of the pixel data of each of the R, G, and B channels is at a low value. For example, as the image data (IDATA) is closer to primary colors, a difference between the pixel data of the R channel, the pixel data of the G channel, and the pixel channel of the B channel is at a high value, so that the standard deviations of the pixel data of the R channel, the pixel data of the G channel, and the pixel data of the B channel are high.

According to an embodiment, the saturation map generator 250 may generate the saturation map based on pixels corresponding to a first color filter, pixels corresponding to a second color filter, and pixels corresponding to a third color filter. For example, the first color filter may correspond to the R channel, the second color filter may correspond to the G channel, or the third color filter may correspond to the B channel. In an example, the saturation map generator 250 may generate the saturation map based on a standard deviation between pixel data of pixels corresponding to the first to third color filters.

According to an embodiment, the saturation map (∂(x,y)) may be calculated using the following equation 1.

In Equation 1, σ (x,y) may correspond to the standard deviation for obtaining the saturation map (∂(x,y)), Xᵢ may correspond to pixel data for each channel, X may correspond to an average of pixel data of (R, G, B) channels, and (x,y) may correspond to coordinates corresponding to the pixel array. Sigma σ may correspond to the standard deviation indicated in Equation 1, which may represent the saturation map ∂(x,y) for an embodiment.

$$σ ( x , y ) = \sqrt{\frac{\sum {( {X}_{i} ( x , y ) - \overline{X} ( x , y ) )}^{2}}{3}} , i = \{ R , G , B \} \qquad [ Equation 1 ]$$

According to an embodiment, when the color corresponding to (1,1) of the image data (IDATA) is black, the pixel data value corresponding to the red channel, the pixel data value corresponding to the green channel, and the pixel data value corresponding to the blue channel may all correspond to zero “0”. At this time, at the (1,1) position, because pixel data of the (R, G, B) channels is denoted by (0, 0, 0), a standard deviation of the (1,1) coordinate may correspond to zero “0”.

According to an embodiment, when the color corresponding to (1,1) of the image data (IDATA) is red, a pixel data value corresponding to the red channel may correspond to 255, and each of a pixel data value corresponding to the green channel and a pixel data value corresponding to the blue channel may correspond to zero “0”. At this time, at the (1,1) position, because the pixel data of the (R, G, B) channels is denoted by (255, 0, 0), the standard deviation of the (1,1) coordinate may correspond to approximately “120.2”.

According to an embodiment, when the color corresponding to (1,1) of the image data (IDATA) is gray, each of a pixel data value corresponding to the red channel, a pixel data value corresponding to the green channel, and a pixel data value corresponding to the blue channel may correspond to 100. At this time, because the pixel data of the (R, G, B) channels at the (1,1) position is denoted by (100, 100, 100), the standard deviation of the (1,1) coordinate may correspond to zero “0”.

According to an embodiment, when the color corresponding to (1,1) of the image data (IDATA) is white, each of a pixel data value corresponding to the red channel, a pixel data value corresponding to the green channel, and a pixel data value corresponding to the blue channel may correspond to 255. At this time, at the (1,1) position, the pixel data of the (R, G, B) channels is denoted by (255, 255, 255), so that the standard deviation of the (1,1) coordinate may correspond to zero “0”.

The RGB image separator 230, the median filter 240, and the saturation map generator 250 based on some implementations of the disclosed technology are only examples and may operate as one module. For example, the saturation map generator 250 may receive image data (IDATA), may classify the received image data (IDATA) into an R image (R_i) composed of pixel data corresponding to a red channel, a G image (G_i) composed of pixel data corresponding to a green channel, and a B image (B_i) composed of pixel data corresponding to a blue channel, and may generate a saturation map a (x,y) based on a standard deviation between pixel data of the R image (R_i), the G image (G_i), and the B image (B_i). The respective components of the RGB image separator 230, the median filter 240, and the saturation map generator 250 based on some implementations of the disclosed technology may be combined with each other or any one component from among all components may be omitted as needed. For example, the median filter 240 may be combined with the RGB image separator 230 or the saturation map generator 250 to operate as a single module. For example, the median filter 240 may be omitted as needed.

According to an embodiment, the grayscale map generator 260 may receive a luminance map Y(x,y) from the luminance map generator 220 and may receive a saturation map ∂(x,y) from the saturation map generator 250. In an example, the grayscale map generator 260 may generate a grayscale map G(x,y) based on the received luminance map Y(x,y) and the received saturation map ∂(x,y). In an example, the grayscale map generator 260 may identify luminance and saturation for each coordinate using the luminance map Y(x,y) and the saturation map ∂(x,y).

According to an embodiment, the grayscale map generator 260 may generate a grayscale map G(x,y) in which coordinate information (x,y) is combined based on the result of comparing the identified luminance for each coordinate with the identified saturation for each coordinate. In an example, data for each coordinate of the grayscale map G(x,y) may correspond to a luminance value for a low saturation region of the image data (IDATA). For example, the grayscale map generator 260 may identify an area having a saturation less than a threshold value in the image data (IDATA), and may apply luminance map (Y(x,y)) data to the identified area, thereby indicating a luminance value for a low-saturation area of the image data (IDATA).

According to an embodiment, the grayscale map generator 260 may identify, in the image data (IDATA), a specific area in which the saturation is greater than or equal to a threshold value and may convert the identified area into data corresponding to white. In an example, the grayscale map generator 260 may set, in the image data (IDATA), pixel data of the area in which the saturation is greater than or equal to a threshold value to a maximum value of 255.

According to an embodiment, the grayscale map G(x,y) may be calculated using Equation 2. In Equation 2, G(x,y) may correspond to a grayscale map, Y(x,y) may correspond to a luminance map, ∂(x,y) may correspond to a saturation map (represented by the standard deviation σ(x,y) shown in Equation 1 for a particular embodiment), ‘Th’ may correspond to a threshold value, and (x,y) may correspond to coordinates corresponding to the pixel array. In an example, the maximum value of the pixel data may correspond to 255.

$$G ( x , y ) = \{ \begin{matrix}Y ( x , y ) , & σ ( x , y ) < Th \\ 255 , & Th \leq σ ( x , y )\end{matrix} \qquad [ Equation 2 ]$$

According to an embodiment, when the color corresponding to (1,1) of the image data (IDATA) is black, the pixel data of the (R, G, B) channels is denoted by (0, 0, 0), and the threshold is 100, the saturation (∂(1,1)) corresponding to (1,1) may correspond to zero “0”. At this time, because the luminance Y(1,1) is 16 (i.e., (0.257×0)+(0.504×0)+(0.098×0)+16=16) based on a conversion method such as the Keith Jack conversion method, the luminance Y(1,1) may correspond to 16. In an example, at the (1,1) position, the saturation is less than a threshold value, so that grayscale map data G(1,1) may correspond to 16 indicating a value of the luminance Y(1,1).

According to an embodiment, when the color corresponding to (1,1) of the image data (IDATA) is red, and the pixel data of the (R, G, B) channels is denoted by (255, 0, 0), and the threshold value is 100, the saturation ∂(1,1) corresponding to (1,1) may correspond to about “120.2”. At this time, because the luminance Y(1,1) is 81.5 (i.e., (0.257×255)+(0.504×0)+(0.098×0)+16=81.5) based on a conversion method such as the Keith Jack conversion method, the luminance Y(1,1) may correspond to 81.6. In an example, at the (1,1) position, the saturation is greater than a threshold value, so that grayscale map data G(1,1) may correspond to 255.

According to an embodiment, when the color corresponding to (1,1) of the image data (IDATA) is green, and the pixel data of the (R, G, B) channels is denoted by (0, 100, 0), and the threshold value is 100, the saturation a (1,1) corresponding to (1,1) may correspond to about 57.7. At this time, because the luminance Y(1,1) is 66.4 (i.e., (0.257×0)+(0.504×100)+(0.098×0)+16=66.4) based on a conversion method such as the Keith Jack conversion method, the luminance Y(1,1) may correspond to 66.4. In an example, at the (1,1) position, the saturation is less than a threshold value, so that grayscale map data G(1,1) may correspond to 66.4 indicating a value of the luminance Y(1,1).

According to an embodiment, when the color corresponding to (1,1) of the image data (IDATA) is gray, and the pixel data of the (R, G, B) channels is denoted by (100, 100, 100), and the threshold value is 100, the saturation a (1,1) corresponding to (1,1) may correspond to zero “0”. At this time, because the luminance Y(1,1) is 101.9 (i.e., (0.257×100)+(0.504×100)+(0.098×100)+16=101.9) based on a conversion method such as the Keith Jack conversion method, the luminance Y(1,1) may correspond to 101.9. In an example, at the (1,1) position, the saturation is less than a threshold value, so that grayscale map data G(1,1) may correspond to 101.9 indicating a value of the luminance Y(1,1).

According to an embodiment, when the color corresponding to (1,1) of the image data (IDATA) is white, the pixel data of the (R, G, B) channels is denoted by (255, 255, 255), and the threshold value is 100, the saturation a (1,1) corresponding to (1,1) may correspond to zero “0”. At this time, because the luminance Y(1,1) is 235.0 (i.e., (0.257×255)+(0.504×255)+(0.098×255)+16=235.0) based on a conversion method such as the Keith Jack conversion method, the luminance Y(1,1) may correspond to 235.0. In an example, at the (1,1) position, the saturation is less than a threshold value, so that grayscale map data G(1,1) may correspond to 235.0 indicating a value of the luminance Y(1,1).

FIG. 3 is a block diagram illustrating an example of the noise corrector 300 based on some implementations of the disclosed technology.

Referring to FIG. 3, the noise corrector 300 may include a dark area detector 310 and a noise calculator 320. In an example, the noise corrector 300 may receive grayscale map (i.e., G(x,y)) data and may output processed image data (IDATA_P). In an example, the processed image data (IDATA_P) may correspond to image data from which noise has been removed from the image data (IDATA). For example, the processed image data (IDATA_P) may correspond to image data obtained when DC offset correction has been performed on the image data (IDATA). For example, the processed image data (IDATA_P) may correspond to image data obtained when a noise value has been subtracted from pixel data of pixels corresponding to an input image.

According to an embodiment, the dark area detector 310 may receive grayscale map (i.e., G(x,y)) data from the mapping data generator 200, and may detect a dark area of the received grayscale map (i.e., G(x,y)) data. In an example, the dark area detector 310 may identify data including the lowest pixel data from among the grayscale map (G(x,y)) data. In an example, the dark area detector 310 may detect an area including the lowest pixel data from among the areas of the grayscale map (G(x,y)) as a dark area.

According to an embodiment, the dark area detector 310 may identify coordinates corresponding to the lowest pixel data from among all coordinates of the grayscale map G(x,y), and may designate an (N×N) area corresponding to the identified coordinate as a dark area. For example, the dark area detector 310 may identify coordinates corresponding to the lowest pixel data from among all coordinates of the grayscale map G(x,y) as (100, 100), and may detect a (3×3) area centered on the identified coordinate (100, 100) as a dark area. For example, the dark area detector 310 may detect areas corresponding to (99, 99), (99, 100), (99, 101), (100, 99), (100, 100), (100, 101), (101, 99), (101, 100), and (101, 101) from among the coordinates of the grayscale map (G(x,y)) as dark areas.

According to an embodiment, the dark area detector 310 may calculate a noise value (BLCᵢ) based on pixel data of pixels included in the dark area. In an example, the dark area detector 310 may identify an average value of pixel data for each channel for pixels included in the dark area having the (N×N) size as the noise value (BLCᵢ).

According to an embodiment, the noise value (BLCᵢ) may be calculated using Equation 3. In Equation 3, BLCᵢ may be a noise value corresponding to the channel ‘i’, ‘i’ may be a channel identification parameter, N may be the size of an area, and (r, c) may be coordinates corresponding to the dark area.

$${BLC}_{i} = \frac{1}{{N}^{2}} {\sum }_{r = 1}^{N} {\sum }_{c = 1}^{N} {X}_{i} ( r , c ) , for i = \{ R , G , B \} \qquad [ Equation 3 ]$$

According to an embodiment, the dark area detector 310 may set the value of N to ‘3’ and may identify coordinates corresponding to the lowest pixel data from among coordinates of the grayscale map G (x,y) centered on (50, 50). At this time, the dark area detector 310 may detect a (3×3) area centered on the identified coordinate (50, 50) as the dark area. In an example, the dark area detector 310 may detect areas corresponding to (49, 49), (49, 50), (49, 51), (50, 49), (50, 50), (50, 51), (51, 49), (51, 50), and (51, 51) from among the coordinates of the grayscale map (G(x,y)) as the dark areas. At this time, among the coordinates of the grayscale map G(x,y), the (R, G, B) channel pixel data of the image data (IDATA) for (49, 49), (49, 50), (49, 51), (50, 49), (50, 50), (50, 51), (51, 49), (51, 50), and (51, 51) may correspond to (100, 0, 0), (100, 0, 0), (100, 0, 0), (100, 0, 0), (100, 0, 0), (100, 0, 0), (100, 0, 0), (100, 0, 0), and (100, 0, 0), respectively. In this case, the formula “BLC_{R}=100, BLC_{G}=0, BLC_{B}=0” may be satisfied.

According to an embodiment, the dark area detector 310 may set the value of N to ‘5’ and may identify coordinates corresponding to the lowest pixel data from among coordinates of the grayscale map G (x,y) centered on (100, 100). At this time, the dark area detector 310 may detect a (5×5) area centered on the identified coordinate (100, 100) as the dark area. In an example, the dark area detector 310 may detect areas corresponding to (98, 98), (98, 99), (98, 100), (98, 101), (98, 102), (99, 98), (99, 99), (99, 100), (99, 101), (99, 102), (100, 98), (100, 99), (100, 100), (100, 101), (100, 102), (101, 98), (101, 99), (101, 100), (101, 101), (101, 102), (102, 98), (102, 99), (102, 100), (102, 101), and (102, 102) from among the coordinates of the grayscale map (G(x,y)) as the dark areas. At this time, among the coordinates of the grayscale map G(x,y), the (R, G, B) channel pixel data of the image data (IDATA) for (98, 98), (98, 99), (98, 100), (98, 101), (98, 102), (99, 98), (99, 99), (99, 100), (99, 101), (99, 102), (100, 98), (100, 99), (100, 100), (100, 101), (100, 102), (101, 98), (101, 99), (101, 100), (101, 101), (101, 102), (102, 98), (102, 99), (102, 100), (102, 101), and (102, 102) may correspond to (50, 50, 30), (51, 50, 30), (52, 50, 30), (53, 50, 30), (54, 50, 30), (55, 50, 30), (56, 50, 30), (57, 50, 30), (58, 50, 30), (59, 50, 30), (60, 50, 30), (61, 50, 30), (62, 50, 30), (63, 50, 30), (64, 50, 30), (65, 50, 30), (66, 50, 30), (67, 50, 30), (68, 50, 30), (69, 50, 30), (70, 50, 30), (71, 50, 30), (72, 50, 30), (73, 50, 30), and (74, 0, 0), respectively. In this case, the formula “BLC_{R}=62, BLC_{G}=50, BLC_{B}=30” may be satisfied.

The above-described BLCᵢ calculation method by the dark area detector 310 is an example, but the scope of the disclosed technology is not limited thereto. According to an embodiment, the dark area detector 310 may identify coordinates corresponding to the lowest pixel data from among the coordinates of the grayscale map G(x,y), and may designate a (M×N) area corresponding to the identified coordinate as a dark area. In an example, the dark area detector 310 may identify the lowest value from among the pixel data of each channel for pixels included in the dark area as a noise value (BLCᵢ).

According to an embodiment, the dark area detector 310 may transmit the noise value (BLCᵢ) to the noise calculator 320. In an example, the dark area detector 310 may detect areas corresponding to (49, 49), (49, 50), (49, 51), (50, 49), (50, 50), (50, 51), (51, 49), (51, 50), and (51, 51) from among the coordinates of the grayscale map G(x,y) as dark areas. At this time, among the coordinates of the grayscale map G(x,y), the (R, G, B) channel pixel data of the image data (IDATA) for (49, 49), (49, 50), (49, 51), (50, 49), (50, 50), (50, 51), (51, 49), (51, 50), and (51, 51) may correspond to (100, 0, 0), (100, 0, 0), (100, 0, 0), (100, 0, 0), (100, 0, 0), (100, 0, 0), (100, 0, 0), (100, 0, 0), and (100, 0, 0), respectively. In this case, the dark area detector 310 may transmit data of “BLC_{R}=100, BLC_{G}=0, and BLC_{B}=0” to the noise calculator 320.

According to an embodiment, the noise calculator 320 may receive a noise value (BLCᵢ) from the dark area detector 310, and may output processed image data (IDATA_P) based on the received noise value (BLCᵢ). In an example, the noise calculator 320 may output processed image data (IDATA_P) by subtracting (BLC_{R}, BLC_{G}, BLC_{B}) from the (R, G, B) channel pixel data of the image data (IDATA).

In more detail, the noise calculator 320 may subtract ‘BLC_{R}’ from all R-channel pixel data of the image data (IDATA), may subtract ‘BLC_{G}’ from all G-channel pixel data of the image data (IDATA), and may subtract ‘BLC_{B}’ from all B-channel pixel data of the image data (IDATA), and may thus output processed image data (IDATA_P).

According to an embodiment, the image data (IDATA) may include pixel data Xᵢ(x,y) of a pixel located at coordinates (x,y) corresponding to the channel ‘i’, and the processed image data (IDATA_P) may include corrected pixel data \tilde{X}ᵢ(x,y). The corrected pixel data \tilde{X}ᵢ(x,y) may be calculated using Equation 4. In Equation 4, Xᵢ(x,y) may be pixel data before correction of the i-channel pixel located at (x,y), \tilde{X}ᵢ(x,y) may correspond to corrected pixel data of the i-channel pixel located at (x,y), and BLCᵢ may correspond to a noise value corresponding to the i-channel.

$${\tilde{X}}_{i} ( x , y ) = {X}_{i} ( x , y ) - {BLC}_{i} \qquad [ Equation 4 ]$$

According to an embodiment, in a situation where pixel data of the (R, G, B) channels for the position (a, b) of image data (IDATA) corresponds to (c, d, e) and ‘BLC_{R}=100, BLC_{G}=0, BLC_{B}=0’ are given, X_{R}(a, b)=c, X_{G}(a, b)=d, and X_{B}(a, b)=e are determined. As a result, the noise calculator 320 may calculate \tilde{X}_{R}(a, b) as denoted by “\tilde{X}_{R}(a, b)=c−100”, may calculate \tilde{X}_{G}(a, b) as denoted by “\tilde{X}_{G}(a, b)=d−0”, and may calculate \tilde{X}_{B}(a, b) as denoted by “\tilde{X}_{B}(a, b)=e−0”. In an example, when the value of \tilde{X}ᵢ(x,y) is less than or equal to zero “0”, the noise calculator 320 may determine the value of \tilde{X}ᵢ(x,y) to be zero “0”. The dark area detector 310 and the noise calculator 320 based on some implementations of the disclosed technology are only examples and may operate as a single module. For example, the noise calculator 320 may receive grayscale map (G(x,y)) data and may calculate a noise value (BLCᵢ). Based on the calculated noise value (BLCᵢ), the noise calculator 320 may subtract (BLC_{R}, BLC_{G}, BLC_{B}) from the (R, G, B) channel pixel data of the image data (IDATA) and may output the processed image data (IDATA_P). In more detail, the noise calculator 320 may subtract ‘BLC_{R}’ from all R-channel pixel data of the image data (IDATA), may subtract ‘BLC_{G}’ from all G-channel pixel data of the image data (IDATA), and may subtract ‘BLC_{B}’ from all B-channel pixel data of the image data (IDATA), and may thus output processed image data (IDATA_P).

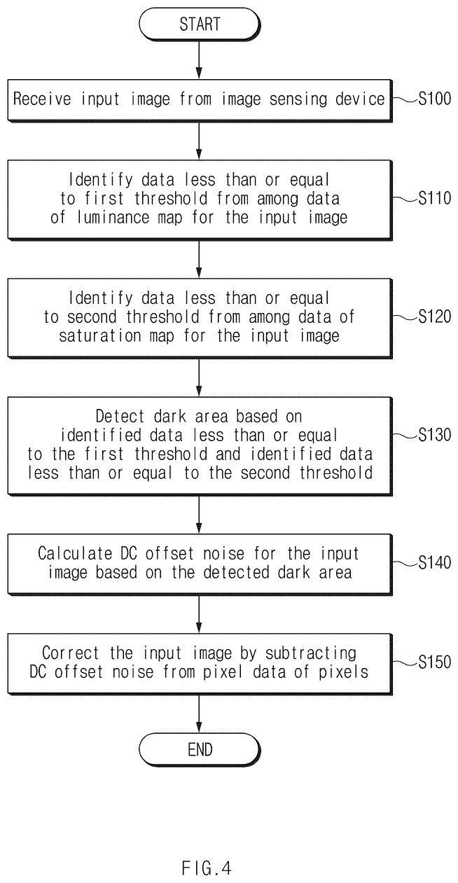

FIG. 4 is a flowchart illustrating an example operation of the image signal processor based on some implementations of the disclosed technology.

Referring to FIG. 4, the image processing device 10 may receive (S100) an input image from the image sensing device. In an example, the image processing device 10 may receive image data (IDATA) using the image sensing device. In an example, the image data (IDATA) may be mapped to correspond to coordinates of the pixel array. For example, the image data (IDATA) may include pixel data X(x,y).

According to an embodiment, the image processing device 10 may identify (S110) data based on a first threshold value from among data of the luminance map for the input image. In an example, the image processing device 10 may extract a luminance map for the received image data (IDATA) and may identify data based on a first threshold value from among data of the luminance map. In an example, the first threshold value may correspond to data of the saturation map ∂(x,y). For example, referring to FIG. 2 together with FIG. 4., the image processing device 10 may generate a luminance map Y(x,y) in which luminance data (Y) is combined with coordinate information (x,y) of the pixel array using the luminance map generator 220. In an example, the image processing device 10 may identify data satisfying a first threshold condition from among data of the luminance map Y(x,y). In an example, the first threshold condition may correspond to a second threshold value, which is described later. In an example, the operation of S110 may correspond to the operations of the luminance image converter 210 and the luminance map generator 220 shown in FIG. 2.

According to an embodiment, the image processing device 10 may identify (S120) data that is less than or equal to a second threshold value from among the saturation map for the input image. In an example, the image processing device 10 may extract a saturation map for the received image data (IDATA), and may identify data that is less than or equal to the second threshold value from among the saturation map data. For example, referring to FIG. 2 together with FIG. 4, the image processing device 10 may generate a saturation map ∂(x,y) using the saturation map generator 250. In an example, the image processing device 10 may identify data that has a saturation value less than or equal to the second threshold value from among data of the saturation map ∂(x,y).

According to an embodiment, the image processing device 10 may generate a saturation map based on the standard deviation between pixel data of pixels corresponding to each of a plurality of channels (e.g., a red channel, a green channel, and a blue channel) from among pixels included in a unit pixel group. In an example, the operation of S120 may correspond to the operations of the RGB image separator 230, the median filter 240, and the saturation map generator 250 shown in FIG. 2.

According to an embodiment, the image processing device 10 may detect (S130) a dark area based on data identified based on a first threshold value and data less than or equal to a second threshold value. In an example, the image processing device 10 may detect a common area between an area corresponding to data identified based on a first threshold value and an area corresponding to data less than or equal to a second threshold value from among areas of the image data (IDATA). In an example, the image processing device 10 may detect, as a dark area, an area including pixels with the lowest pixel data from among one or more common areas between an area corresponding to data identified based on a first threshold value and an area corresponding to data less than or equal to a second threshold value. In an example, the operation of S130 may correspond to the operations of the grayscale map generator 260 of FIG. 2 and the dark area detector 310 shown in FIG. 3.

According to an embodiment, the image processing device 10 may calculate (S140) DC offset noise for the input image based on the detected dark area. In an example, the image processing device 10 may calculate an average value between pixel data of pixels corresponding to a channel of a color from among pixels included in the detected dark area as a DC offset noise value. For example, the image processing device 10 may determine an average value between pixel data of pixels corresponding to a red channel from among pixels included in the dark area as a DC offset noise value for pixels corresponding to the red channel, may determine an average value between pixel data of pixels corresponding to a green channel from among pixels included in the dark area as a DC offset noise value for pixels corresponding to the green channel, and may determine an average value between pixel data of pixels corresponding to a blue channel from among pixels included in the dark area as a DC offset noise value for pixels corresponding to the blue channel. In an example, the operations of S140 may correspond to the operations of the dark area detector 310 shown in FIG. 3.

According to an embodiment, the image processing device 10 may correct (S150) the input image by subtracting the calculated DC offset noise from the pixel data of the pixels. In an example, the image processing device 10 may subtract, from the (R, G, B) channel pixel data of the image data (IDATA), a first average value between pixel data of the pixels corresponding to the red channel from among the pixels included in the dark area, a second average value between pixel data of the pixels corresponding to the green channel from among the pixels included in the dark area, and a third average value between pixel data of the pixels corresponding to the blue channel from among the pixels included in the dark area. Here, the first average value, the second average value, and the third average value are calculated in operation S140.

According to an embodiment, the image processing device 10 may remove a DC offset noise value from all red channel pixel data of the image data (IDATA) by subtracting an average value between pixel data of pixels corresponding to a red channel from among pixels included in the dark area, with respect to all red channel pixel data of the image data (IDATA). In an example, the image processing device 10 may remove a DC offset noise value from all green channel pixel data of the image data (IDATA) by subtracting an average value between pixel data of pixels corresponding to a green channel from among pixels included in the dark area for all green channel pixel data of the image data (IDATA). In an example, the image processing device 10 may remove a DC offset noise value from all blue channel pixel data of the image data (IDATA) by subtracting an average value between pixel data of pixels corresponding to a blue channel from among pixels included in the dark area, with respect to all blue channel pixel data of the image data (IDATA). In an example, the operation of S150 may correspond to the operations of the noise calculator 320 shown in FIG. 3.

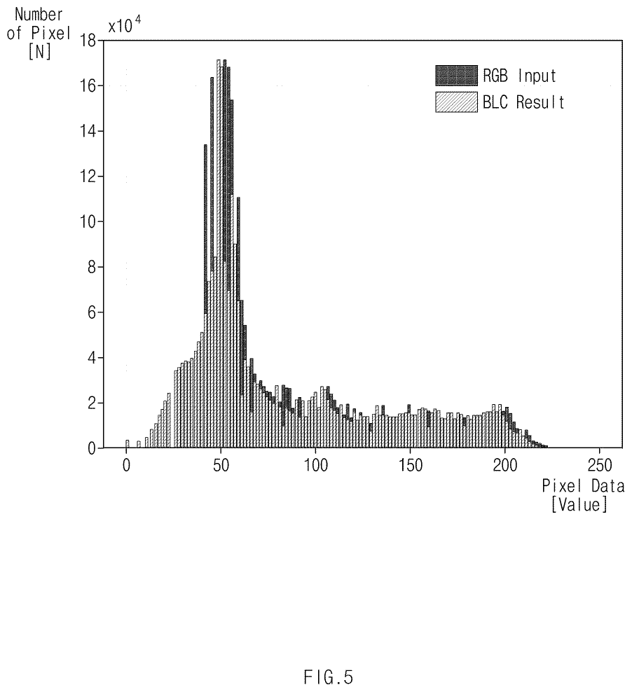

FIG. 5 is a graph illustrating an example of pixel data in a high-illuminance environment based on some implementations of the disclosed technology.

Referring to FIG. 5, pixel data in the high-illuminance environment may include pixel data corresponding to image data (IDATA) and pixel data corresponding to processed image data (IDATA_P). In an example, the image processing device 10 may receive image data (IDATA) and generate processed image data (IDATA_P) in the environment where ‘20 Lux’ and an 8-times analog gain (i.e., 8× analog gain) are set.

According to an embodiment, the number of pixels (i.e., denoted by “RGB Input”) according to pixel data for image data (IDATA) corresponds to a black bar graph. In an example, the number of pixels (i.e., denoted by “BLC Result”) according to pixel data for processed image data (IDATA_P) corresponds to a dot-pattern bar graph. According to an embodiment, because a relatively low gain (e.g., an analog gain and/or a digital gain) is used in a high-illuminance environment (e.g., 20 Lux), less DC offset distortion due to the gain may occur in the operation of generating pixel data. Therefore, the image processing device 10 may identify the noise value (BLCᵢ) as a relatively low value.

According to an embodiment, it can be seen that the number of pixels (BLC Result) according to pixel data for the processed image data (IDATA_P) is shifted in the pixel data direction in which the number of pixels (BLC result) according to pixel data for the processed image data (IDATA_P) is overall smaller than the number of pixels (RGB Input) according to pixel data for the image data (IDATA). In an example, the image processing device 10 may generate processed image data (IDATA_P) by subtracting the noise value (BLCᵢ) from all pixel data of the image data (IDATA), so that the shift value in the direction of the lower pixel data may correspond to the noise value (BLCᵢ).

According to an embodiment, in the environment where 20 Lux and an 8-times (8×) analog gain are set, it can be confirmed that the shift value of the number of pixels (BLC Result) according to pixel data for the processed image data (IDATA_P) is relatively low, based on the number of pixels (RGB Input) according to pixel data for the image data (IDATA).

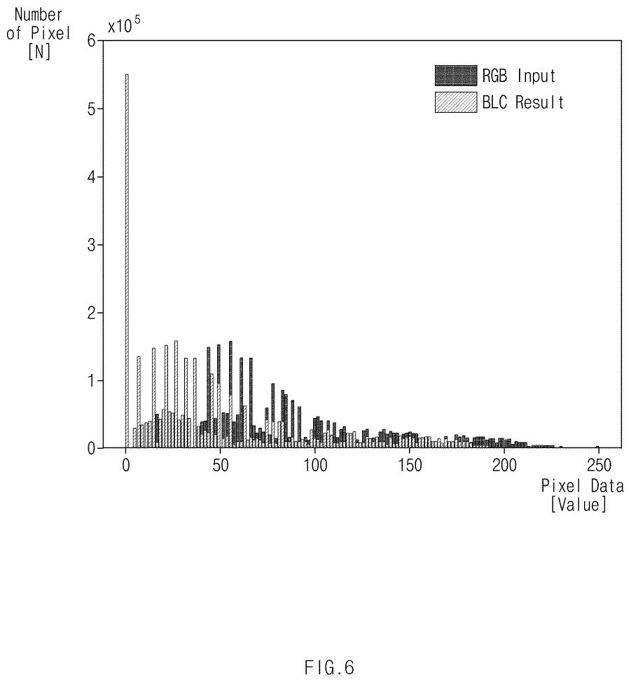

FIG. 6 is a graph illustrating an example of pixel data in a medium-illuminance environment based on some implementations of the disclosed technology.

Referring to FIG. 6, pixel data in the medium-illuminance environment may include pixel data corresponding to the image data (IDATA) and pixel data corresponding to the processed image data (IDATA_P). In an example, the image processing device 10 may receive the image data (IDATA) and generate the processed image data (IDATA_P) in the environment where 1 Lux, an analog gain of 16 times (16× analog gain) and a digital gain of 7.99 times (7.99× digital gain) are set.

According to an embodiment, the number of pixels (RGB Input) according to pixel data for image data (IDATA) corresponds to a black bar graph. In an example, the number of pixels (BLC Result) according to pixel data for processed image data (IDATA_P) corresponds to a dot-pattern bar graph. According to an embodiment, because a medium gain (e.g., an analog gain and/or a digital gain) is used in a medium-illuminance environment (e.g., 1 Lux), medium DC offset distortion due to the gain may occur in the operation of generating pixel data. Therefore, the image processing device 10 may identify the noise value (BLCᵢ) as a medium value.

According to an embodiment, it can be seen that the number of pixels (BLC Result) according to pixel data for the processed image data (IDATA_P) is shifted to a medium level in the pixel data direction in which the number of pixels (BLC result) according to pixel data for the processed image data (IDATA_P) is overall smaller than the number of pixels (RGB Input) according to pixel data for the image data (IDATA). In an example, the image processing device 10 may generate processed image data (IDATA_P) by subtracting the noise value (BLCᵢ) from all pixel data of the image data (IDATA), so that the shift value in the direction of the lower pixel data may correspond to the noise value (BLCᵢ).

According to an embodiment, in the environment where 1 Lux, a 16-times (16×) analog gain, and a 7.99-times (7.99×) digital gain are set, it can be confirmed that the shift value of the number of pixels (BLC Result) according to pixel data for the processed image data (IDATA_P) is medium in level, based on the number of pixels (RGB Input) according to pixel data for the image data (IDATA).

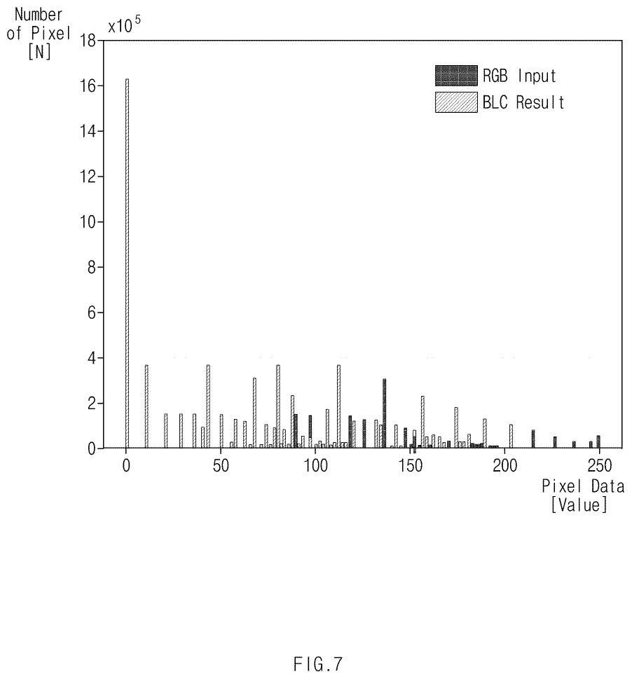

FIG. 7 is a graph illustrating an example of pixel data in a low-illuminance environment based on some implementations of the disclosed technology.

Referring to FIG. 7, pixel data in the low-illuminance environment may include pixel data corresponding to the image data (IDATA) and pixel data corresponding to the processed image data (IDATA_P). In an example, the image processing device 10 may receive the image data (IDATA) and generate the processed image data (IDATA_P) in the environment where 0.1 Lux, an analog gain of 16 times (16× analog gain) and a digital gain of 16 times (16× digital gain) are set.

According to an embodiment, the number of pixels (RGB Input) according to pixel data for image data (IDATA) corresponds to a black bar graph. In an example, the number of pixels (BLC Result) according to pixel data for processed image data (IDATA_P) corresponds to a dot-pattern bar graph. According to an embodiment, because a relatively high gain (e.g., an analog gain and/or a digital gain) is used in a low-illuminance environment (e.g., 0.1 Lux), large DC offset distortion due to the gain may occur in the operation of generating pixel data. Therefore, the image processing device 10 may identify the noise value (BLCᵢ) as a relatively high value.

According to an embodiment, it can be seen that the number of pixels (BLC Result) according to pixel data for the processed image data (IDATA_P) is shifted in the pixel data direction in which the number of pixels (BLC result) according to pixel data for the processed image data (IDATA_P) is overall smaller than the number of pixels (RGB Input) according to pixel data for the image data (IDATA). In an example, the image processing device 10 may generate processed image data (IDATA_P) by subtracting the noise value (BLCᵢ) from all pixel data of the image data (IDATA), so that the shift value in the direction of the lower pixel data may correspond to the noise value (BLCᵢ).

According to an embodiment, in the environment where 0.1 Lux, a 16-times (16×) analog gain, and a 16-times (16×) digital gain are set, it can be confirmed that the shift value of the number of pixels (BLC Result) according to pixel data for the processed image data (IDATA_P) is relatively large, based on the number of pixels (RGB Input) according to pixel data for the image data (IDATA).

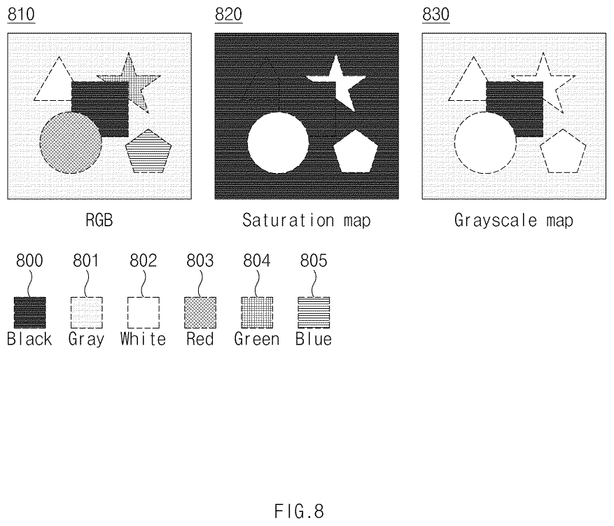

FIG. 8 is a diagram illustrating an example of mapping data based on some implementations of the disclosed technology.

Referring to FIG. 2 and FIG. 8, the mapping data generator 200 may identify an RGB image 810 from the image data (IDATA), may generate a saturation map 820 using the saturation map generator 250, and may generate a grayscale map 830 using the grayscale map generator 260. In an example, the RGB image 810 may correspond to an image that includes a black square 800 in which pixel data of the (R, G, B) channels is (0, 0, 0), a gray background 801 in which pixel data of the (R, G, B) channels is (100, 100, 100), a white triangle 802 in which pixel data of the (R, G, B) channels is (255, 255, 255), a red circle 803 in which pixel data of the (R, G, B) channels is (255, 0, 0), a green star 804 in which pixel data of the (R, G, B) channels is (0, 255, 0), and a blue pentagon 805 in which pixel data of the (R, G, B) channels is (0, 0, 255).

According to an embodiment, the saturation map generator 250 may identify the standard deviation as zero “0” because the (R, G, B) channel pixel data for the area corresponding to the square is (0, 0, 0). Therefore, the saturation map generator 250 may set the value of a portion corresponding to the square shape of the saturation map 820 to zero “0”.

According to an embodiment, the saturation map generator 250 may identify the standard deviation as zero “0” because the (R, G, B) channel pixel data for the area corresponding to the background is (100, 100, 100). Therefore, the saturation map generator 250 may set the value of a portion corresponding to the background of the saturation map 820 to zero “0”.

According to an embodiment, the saturation map generator 250 may identify the standard deviation as zero “0” because the (R, G, B) channel pixel data for the area corresponding to the triangle is (0, 0, 0). Therefore, the saturation map generator 250 may set the value of a portion corresponding to the triangle of the saturation map 820 to zero “0”.

According to an embodiment, the saturation map generator 250 may identify the standard deviation as approximately “120.2” because the (R, G, B) channel pixel data for the area corresponding to the circle is (255, 0, 0). Therefore, the saturation map generator 250 may set the value of a portion corresponding to the circle of the saturation map 820 to approximately “120.2”.

According to an embodiment, the saturation map generator 250 may identify the standard deviation as approximately “120.2” because the (R, G, B) channel pixel data for the area corresponding to the star shape is (0, 255, 0). Therefore, the saturation map generator 250 may set the value of a portion corresponding to the star shape of the saturation map 820 to approximately “120.2”.

According to an embodiment, the saturation map generator 250 may identify the standard deviation as approximately “120.2” because the (R, G, B) channel pixel data for the area corresponding to the pentagonal shape is (0, 0, 255). Therefore, the saturation map generator 250 may set the value of a portion corresponding to the pentagonal shape of the saturation map 820 to approximately “120.2”.

According to an embodiment, the grayscale map generator 260 may identify the standard deviation as zero “0” because the (R, G, B) channel pixel data for the area corresponding to the square is (0, 0, 0). At this time, the luminance for the area corresponding to the square is set to, for example, 16 (=(0.257×0)+(0.504×0)+(0.098×0)+16) based on the Keith Jack conversion method, and thus the standard deviation value (i.e., saturation) is smaller than the threshold value when a threshold value is 100, so that the grayscale map generator 260 may set the value of the portion corresponding to the square of the grayscale map 260 to the luminance value of 16.

According to an embodiment, the grayscale map generator 260 may identify the standard deviation as zero “0” because the (R, G, B) channel pixel data for the area corresponding to the background is (100, 100, 100). At this time, the luminance for the area corresponding to the square is set to, for example, 101.9 (=(0.257×100)+(0.504×100)+(0.098×100)+16) based on the Keith Jack conversion method, and thus the standard deviation value (i.e., saturation) is smaller than the threshold value when a threshold value is 100, so that the grayscale map generator 260 may set the value of the portion corresponding to the background of the grayscale map 260 to the luminance value of 101.9.

According to an embodiment, the grayscale map generator 260 may identify the standard deviation as zero “0” because the (R, G, B) channel pixel data for the area corresponding to the triangle is (255, 255, 255). At this time, the luminance for the area corresponding to the triangle is set to, for example, 235.0 (=(0.257×255)+(0.504×255)+(0.098×255)+16) based on the Keith Jack conversion method, and thus the standard deviation value (i.e., saturation) is smaller than the threshold value when a threshold value is 100, so that the grayscale map generator 260 may set the value of the portion corresponding to the triangle of the grayscale map 260 to the luminance value of 235.0.

According to an embodiment, the grayscale map generator 260 may identify the standard deviation as “120.2” because the (R, G, B) channel pixel data for the area corresponding to the circular shape is (255, 0, 0). At this time, because the standard deviation value (saturation) for the area corresponding to the circular shape is higher than the threshold value when a threshold value is 100, the grayscale map generator 260 may set the value of a portion corresponding to the circular shape of the grayscale map 260 to the luminance value of 255.

According to an embodiment, the grayscale map generator 260 may identify the standard deviation as “120.2” because the (R, G, B) channel pixel data for the area corresponding to the star shape is (0, 255, 0). At this time, because the standard deviation value (saturation) for the area corresponding to the star shape is higher than the threshold value when a threshold value is 100, the grayscale map generator 260 may set the value of a portion corresponding to the star shape of the grayscale map 260 to the luminance value of 255.

According to an embodiment, the grayscale map generator 260 may identify the standard deviation as “120.2” because the (R, G, B) channel pixel data for the area corresponding to the pentagonal shape is (0, 0, 255). At this time, because the standard deviation value (saturation) for the area corresponding to the pentagonal shape is higher than the threshold value when a threshold value is 100, the grayscale map generator 260 may set the value of a portion corresponding to the pentagonal shape of the grayscale map 260 to the luminance value of 255.

According to an embodiment, referring to FIG. 3 together, because the lowest pixel data of the grayscale map 830 is pixel data of a pixel included in the area corresponding to a square, the dark area detector 310 may calculate a noise value (BLCᵢ) based on the pixel data of the pixel included in an area corresponding to the square. In an example, the lowest pixel data detected by the dark area detector 310 or average pixel data of the area including the lowest pixel data may correspond to a DC offset. In an example, the dark area detector 310 may remove the DC offset noise by subtracting either the lowest pixel data or the average pixel data of the area including the lowest pixel data, for each channel, from pixel data of all pixels.

The RGB image 810, the saturation map 820, and the grayscale map 830 of FIG. 8 based on some implementations of the disclosed technology are merely examples showing the contrast between pixel data corresponding to the respective shapes included in the image, and the same pixel data might not correspond to the same color or pattern. For example, although the background color of the RGB image 810 and the background color of the grayscale map 830 are depicted as the same color, the (R, G, B) channel pixel data of the area corresponding to the background of the RGB image 810 may correspond to (100, 100, 100), and the value of the area corresponding to the background of the grayscale map 260 may correspond to the luminance value of 101.9. For example, although the circle and triangle shapes of the grayscale map 260 are depicted in the same color, the grayscale map data value of the portion corresponding to the circle of the grayscale map 260 may correspond to 255, and the grayscale map data value of the portion corresponding to the triangle of the grayscale map 260 may correspond to the luminance value of 235.0.

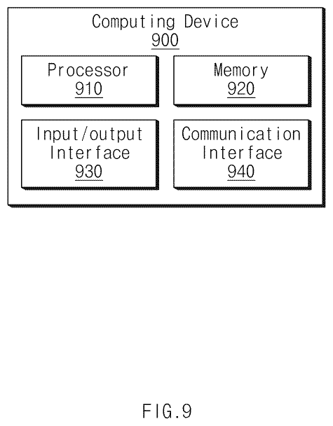

FIG. 9 is a block diagram showing an example of a computing device 900 corresponding to the image signal processor of FIG. 1.

Referring to FIG. 9, the computing device 900 may represent an embodiment of a hardware configuration for performing the operation of the image signal processor 100 of FIG. 1.

The computing device 900 may be mounted on a chip that is independent from the chip on which the image sensing device is mounted. According to an embodiment, the chip on which the image sensing device is mounted and the chip on which the computing device 900 is mounted may be implemented in one package, for example, a multi-chip package (MCP), but the scope of the disclosed technology is not limited thereto.

Additionally, the internal configuration or arrangement of the image sensing device and the image signal processor 100 described in FIG. 1 may vary depending on the embodiment. For example, at least a portion of the image sensing device may be included in the image signal processor 100. Alternatively, at least a portion of the computing device 900 may be included in the image sensing device. In this case, at least a portion of the computing device 900 may be mounted on a chip on which the image sensing device is also mounted.

The computing device 900 may include a processor 910, memory 920, an input/output interface 930, and a communication interface 940.

The processor 910 may process data and/or instructions required to perform the operations of the components (200, 300) of the image signal processor 100 described in FIG. 1. That is, the processor 910 may refer to the image signal processor 100, but the scope of the disclosed technology is not limited thereto.

The memory 920 may store data and/or instructions required to perform operations of the components (200, 300) of the image signal processor 100, and may be accessed by the processor 910. For example, the memory 920 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), EEPROM (Electrically Erasable PROM), flash memory, etc.).

That is, the computer program for performing the operations of the image signal processor 100 disclosed in this document may be recorded or stored in the memory 920 and executed and processed by the processor 910, thereby implementing the operations of the image signal processor 100.

The input/output interface 930 is an interface that connects an external input device (e.g., keyboard, mouse, touch panel, etc.) and/or an external output device (e.g., display) to the processor 910 to allow data to be transmitted and received.

The communication interface 940 is a component that can transmit and receive various data with an external device (e.g., an application processor, external memory, etc.), and may be a device that supports wired or wireless communication.

As is apparent from the above description, an image processing device based on some implementations of the disclosed technology may generate a high-contrast image even when DC offset noise occurs.

Even when a noise value is amplified by applying an analog gain or a digital gain to the image processing device in the low-illuminance environment, the image processing device may correct the amplified noise value for some embodiments.

Some embodiments of the disclosed technology may provide a variety of effects capable of being directly or indirectly recognized as described in this patent document.

Although a number of illustrative embodiments have been described, it should be understood that modifications and enhancements to the disclosed embodiments and other embodiments can be devised based on what is described and/or illustrated in this patent document. Therefore, the scope of the disclosed technology should not be limited to the above-described embodiments but should include the equivalents thereof.

What is claimed is:

1. An image processing device comprising:
a grayscale map generator configured to selectively identify a luminance map data based on a saturation map and a luminance map that correspond to an input image, and configured to generate a grayscale map based on the identified luminance map data; and
a noise corrector configured to generate processed image data for which a noise value for the input image is corrected based on the grayscale map.

2. The image processing device according to claim 1, further comprising:
a saturation map generator configured to generate the saturation map based on pixels corresponding to a first color filter, pixels corresponding to a second color filter, and pixels corresponding to a third color filter.

3. The image processing device according to claim 2, wherein the saturation map generator is configured to:
generate the saturation map based on a standard deviation between pixel data of pixels corresponding to the first, second, and third color filters.

4. The image processing device according to claim 1, wherein the grayscale map generator is configured to generate the grayscale map by:
converting data having a threshold value or higher from among data of the saturation map into data corresponding to white; and
converting data less than the threshold value from among the data of the saturation map into data of the luminance map.

5. The image processing device according to claim 1, wherein:
the processed image data is image data for which the noise value is subtracted from pixel data of pixels corresponding to the input image.

6. The image processing device according to claim 1, wherein:
the noise value is DC offset noise value associated with pixel data of pixels corresponding to the input image.

7. The image processing device according to claim 1, wherein the noise corrector includes:
a dark area detector configured to detect a dark area from among areas of the grayscale map; and
a noise calculator configured to calculate the noise value for the input image based on pixel data for at least one pixel included in the dark area.

8. The image processing device according to claim 7, wherein the dark area detector is configured to:
identify data including the lowest pixel data from among data of the grayscale map; and
detect an area corresponding to data including the identified lowest pixel data as the dark area.

9. The image processing device according to claim 7, wherein the noise calculator is configured to:
determine the pixel data for the at least one pixel included in the dark area as the noise value.

10. The image processing device according to claim 7, wherein the noise calculator is configured to calculate:
a first color average obtained by calculating an average between pixel data of pixels corresponding to a first color filter from among pixels included in the dark area;
a second color average obtained by calculating an average between pixel data of pixels corresponding to a second color filter from among pixels included in the dark area; and
a third color average obtained by calculating an average between pixel data of pixels corresponding to a third color filter from among pixels included in the dark area.

11. The image processing device according to claim 10, wherein the noise calculator is configured to correct the input image by:
subtracting the first color average from pixel data for pixels corresponding to the first color filter from among pixels corresponding to the input image;
subtracting the second color average from pixel data for pixels corresponding to the second color filter from among pixels corresponding to the input image; and
subtracting the third color average from pixel data for pixels corresponding to the third color filter from among pixels corresponding to the input image.

12. An image processing device comprising:
a saturation map generator configured to generate a saturation map based on a standard deviation between pixel data for a plurality of pixels;
a luminance map generator configured to generate a luminance map by extracting luminance information from the plurality of pixels;
a grayscale map generator configured to selectively identify a luminance map data based on the saturation map and the luminance map, and configured to generate a grayscale map based on the identified luminance map data; and
a dark area detector configured to detect a dark area from among areas of the grayscale map.

13. An image processing method comprising:
identifying data based on a first threshold value from among data of a luminance map for an input image;
identifying data that is less than or equal to a second threshold value from among data of a saturation map for the input image;
detecting a dark area based on the data that is less than or equal to the first threshold value and the data that is less than or equal to the second threshold value; and
calculating a direct current DC offset noise value for the input image based on the detected dark area.

14. The image processing method according to claim 13, further comprising:
classifying and separating pixels corresponding to the input image into pixels corresponding to each of a plurality of channels.

15. The image processing method according to claim 14, wherein:
the plurality of channels includes a red channel, a green channel, and a blue channel.

16. The image processing method according to claim 14, wherein classifying and separating the pixels corresponding to the input image into the pixels corresponding to each of the plurality of channels includes:
performing pre-processing to remove pixel noise from the input image.

17. The image processing method according to claim 14, further comprising:
generating the saturation map based on a standard deviation between pixel data of the pixels corresponding to each of the plurality of channels from among pixels included in a unit pixel group.

18. The image processing method according to claim 13, wherein detecting the dark area includes:
detecting a common region between an area corresponding to data identified based on the first threshold value and an area corresponding to data less than or equal to the second threshold value from among areas of the input image.

19. The image processing method according to claim 13, wherein calculating the DC offset noise includes:
calculating an average value between pixel data of pixels corresponding to a channel of a color from among pixels included in the detected dark area.

20. The image processing method according to claim 19, wherein calculating the DC offset noise further includes:
correcting the input image by subtracting the calculated average value from pixel data of pixels corresponding to the channel of color from among pixels corresponding to the input image.
